(19) United States
(12) Patent Application Publication
(10) Pub. No.: US 2026/0128421 A1
(43) Pub. Date: May 7, 2026

(54) SILICA AEROGEL POWDER USED IN THERMAL INSULATOR FOR BATTERY PACK AND THERMAL INSULATOR FOR BATTERY PACK

(71) Applicants: SUMITOMO RIKO COMPANY LIMITED, Aichi (JP); TIEM FACTORY INC., Ibaraki (JP)

(72) Inventors: Shigeaki TAKAMATSU, Aichi (JP); Shota HAYASHI, Aichi (JP); Koichiro TACHIBANA, Ibaraki (JP); Ryota UEOKA, Ibaraki (JP); Shusaku TSUTSUMI, Ibaraki (JP)

(73) Assignees: SUMITOMO RIKO COMPANY LIMITED, Aichi (JP); TIEM FACTORY INC., Ibaraki (JP)

(21) Appl. No.: 19/439,759

(22) Filed: Jan. 5, 2026

Related U.S. Application Data
(63) Continuation of application No. PCT/JP2025/009356, filed on Mar. 12, 2025.

(30) Foreign Application Priority Data
Mar. 25, 2024 (JP) 2024-047766

(51) Int. Cl. H01M 10/658; C01B 33/158; H01M 10/625

(52) U.S. Cl. CPC H01M 10/658; C01B 33/1585; H01M 10/625; C01P 2004/61; C01P 2006/12; C01P 2006/14; C01P 2006/32; H01M 2220/20

(57) ABSTRACT

When a silica aerogel powder used in a thermal insulator for a battery pack is measured by a nitrogen adsorption amount measurement method, a specific surface area and a pore volume at a relative pressure of 0.99 measured based on an adsorption isotherm that is obtained are 550 m²/g or more, and 3.5 mL/g or more and 5.0 mL/g or less, respectively, and when a [mL/g] is a pore volume at a relative pressure of 0.93, b [mL/g] is a pore volume at a relative pressure of 0.965, and c [mL/g] is a pore volume at a relative pressure of 0.99, the following conditions (i) and (ii) are satisfied:

$$0 \leq ( a / c \times 100 ) \leq 50 \qquad ( i )$$

$$50 \leq ( b / c \times 100 ) < 100 \qquad ( ii )$$

### CLAIM FOR PRIORITY

This application is a Continuation of PCT/JP2025/009356 filed Mar. 12, 2025, the contents of which is expressly incorporated by reference herein in its entirety.

### TECHNICAL FIELD

The present disclosure relates to a thermal insulator disposed between adjacent battery cells in a battery pack in which a plurality of battery cells is accommodated, and specifically to a thermal insulator using a silica aerogel powder or silica aerogel.

### BACKGROUND ART

A battery pack in which a plurality of battery cells is accommodated is mounted in hybrid electric vehicles and battery electric vehicles. In the battery pack, a battery module formed by laminating a plurality of battery cells is accommodated in a casing in a state in which the battery module is fixed by fastening members from both sides in a lamination direction. A thermal insulator is disposed between adjacent battery cells in order to suppress heat transfer and thermal runaway when battery cells overheat abnormally. The battery cells expand and contract as a result of charging and discharging. Therefore, it is preferable for the thermal insulator disposed between the battery cells to be able to deform in response to the expansion and contraction of the battery cells while maintaining its thermal insulation. More specifically, when the battery cell is charged and expands, the thickness of the thermal insulator is reduced due to the compressive force, and at the same time, it is necessary to generate a reaction force equal to or above a certain value to energize the battery cell and avoid positional displacement of the battery cell. In addition, when the battery cell is discharged and contracts (returns to its original thickness), the thickness of the thermal insulator also needs to be returned.

Silica aerogels having low thermal conductivity are known as thermal insulator materials. For example, Patent Document 1 describes an aerogel powder with excellent flexibility and resistance to breakage under compressive force, the aerogel powder being made of an aerogel that is a hydrolysis condensation product of a silane compound. The silane compound as a raw material satisfies 0≤Qx≤70, 30≤Tx≤100, 0≤Dx<30 (where Qx+Tx+Dx=100), when Qx, Tx, and Dx are mass percentages of a tetrafunctional silane compound, a trifunctional silane compound, and a bifunctional silane compound, respectively. Patent Document 2 describes a silica aerogel as an example of an aerogel used in an aerogel composite. Paragraphs [0023] and [0025] of Patent Document 2 describe, as physical and structural properties of the aerogel, (a) an average pore diameter of 2 nm to 100 nm, (b) a porosity of 80% or more, (c) a surface area of 20 m²/g or more, (d) a pore volume of 2.0 mL/g or more, and the like, as determined by a nitrogen porosity measurement test.

### RELATED ART DOCUMENTS

### Patent Documents

Patent Document 1: Japanese Unexamined Patent Application Publication No. 2021-165387 (JP 2021-165387 A)
Patent Document 2: Japanese Unexamined Patent Application Publication No. 2023-27128 (JP 2023-27128 A)

### SUMMARY OF THE INVENTION

### Problem to be Solved by the Invention

Patent Document 1 describes the use of a predetermined silane compound as a raw material in order to improve the flexibility and resistance to breakage (a property of being difficult to break) of the aerogel powder under compressive force. However, Patent Document 1 does not describe imparting compression recovery to a silica aerogel, that is, imparting the ability to deform under load and return to its original state upon unloading. In addition, Patent Document 1 describes that, when pores are approximated as a tube and the inner diameter of the tube is approximated as a circle, the pore portion of the aerogel is in the range of 5 nm or more and 100 nm or less. In addition, Patent Document 1 describes that the inner diameter of the tube is equal to or smaller than the mean free path of elemental molecules constituting air under atmospheric pressure. However, Patent Document 1 simply describes the size of the pore portion (pores) of the aerogel but does not provide any technical concept focusing on and specifying the pore structure to achieve desired properties. Similarly, in Patent Document 2, as a general structure of the aerogel, the values of the surface area and the pore volume are described, and there is no examination of the pore structure.

The present disclosure has been made in view of the above circumstances, and provides a silica aerogel powder having excellent thermal insulation and compression recovery and used in a thermal insulator for a battery pack, and a thermal insulator for a battery pack using the same. The present disclosure also provides a thermal insulator for a battery pack using a silica aerogel having excellent thermal insulation and compression recovery.

### Means for Solving the Problem

(1) In order to solve the above issue, a silica aerogel powder of the present disclosure is a silica aerogel powder used in a thermal insulator for a battery pack, and is characterized in that, when the silica aerogel powder is measured by a nitrogen adsorption amount measurement method, a specific surface area and a pore volume at a relative pressure of 0.99 measured based on an adsorption isotherm that is obtained are 550 m²/g or more, and 3.5 mL/g or more and 5.0 mL/g or less, respectively, and when a [mL/g] is a pore volume at a relative pressure of 0.93, b [mL/g] is a pore volume at a relative pressure of 0.965, and c [mL/g] is a pore volume at a relative pressure of 0.99, the following conditions (i) and (ii) are satisfied:

$$0 \leq ( a / c \times 100 ) \leq 50 \qquad ( i )$$

$$50 \leq ( b / c \times 100 ) < 100 . \qquad ( ii )$$

In the present disclosure, the pore structure of the silica aerogel powder is specified to achieve desired thermal insulation and compression recovery. First, by setting the specific surface area to 550 m²/g or more, the proportion of micropores (so-called micropores) with a pore diameter (pore size) of approximately several nanometers is reduced. Thereby, the proportion of pores with a pore diameter of approximately 30 to 68 nm, the pores being effective in improving thermal insulation, relatively increases. Second, by setting the pore volume at a relative pressure of 0.99 to 3.5 mL/g or more and 5.0 mL/g or less, the proportion of pores with a desired pore diameter is increased. In the nitrogen adsorption amount measurement method, when the pore shape is assumed to be cylindrical, the measured “pore volume at a relative pressure of 0.99” can be considered to be the volume of pores with a pore diameter of up to approximately 100 nm. When there are many large pores with a pore diameter exceeding 100 nm, the thermal insulation is reduced, the framework tends to collapse during compression, and thus desired recovery is not obtained. Therefore, in the silica aerogel powder of the present disclosure, by focusing on the pore volume at a relative pressure of 0.99, and setting the pore volume to be a value within a predetermined range, particles containing a large number of pores with a pore diameter exceeding 100 nm are excluded, so that the silica aerogel powder contains pores with a pore diameter that contributes to thermal insulation and compression recovery.

In the nitrogen adsorption amount measurement method, it is thought that the pore volume including pores with a pore diameter of more than 100 nm cannot be measured in a range in which the relative pressure is 0.99 or less. However, in the present disclosure, since target pores are those contributing to thermal insulation and compression recovery of the silica aerogel powder, the above conditions (i) and (ii) are set on the assumption that the “pore volume at a relative pressure of 0.99” is close to the “total pore volume.” In the nitrogen adsorption amount measurement method, if the pore shape is assumed to be cylindrical, the “pore volume at a relative pressure of 0.93” can be considered to be the volume of pores with a pore diameter of up to approximately 30 nm, and the “pore volume at a relative pressure of 0.965” can be considered to be the volume of pores with a pore diameter of up to approximately 68 nm.

In the condition (i), when the proportion of the pore volume (a) at a relative pressure of 0.93 is 50% or less, the number of pores with a pore diameter of up to approximately 30 nm decreases, and the number of pores with a relatively large pore diameter increases, which is advantageous for improving the compression recovery. In the condition (ii), when the proportion of the pore volume (b) at a relative pressure of 0.965 is 50% or more, the number of pores with a pore diameter equal to or smaller than the mean free path (68 nm) of air increases. In the pores with a pore diameter equal to or smaller than the mean free path of air, the heat conduction of air is minimized. Therefore, an increase in the number of such pores is advantageous for improving thermal insulation. In this manner, the silica aerogel powder of the present disclosure in which the specific surface area and the pore volume at a relative pressure of 0.99 are within predetermined ranges, and the conditions (i) and (ii) are satisfied has high thermal insulation and excellent compression recovery.

(2) A first thermal insulator for a battery pack of the present disclosure includes the silica aerogel powder according to the above configuration (1). According to the thermal insulator for a battery pack of the present disclosure, the thermal insulator deforms in response to the expansion and contraction of the battery cells, and thus it is possible to suppress positional displacement and maintain high thermal insulation. In addition, since the expansion and contraction of the battery cells are maintained appropriately, this can contribute to prolonging the lifespan of the battery cells.

(3) In the configuration according to (2), the thermal insulator for a battery pack of the present disclosure may include a press-molded component of a composition containing the silica aerogel powder. In the press-molded component, the silica aerogel particles are in contact with each other at points, lines, or surfaces, and the amount of deformation in the thickness direction increases because the particles move in a displaced manner when compressed from the outside.

(4) In the configuration according to (2) or (3), the thermal insulator for a battery pack of the present disclosure may further include at least one selected from among infrared shielding particles, inorganic fibers, and dispersants. In the configuration according to (3), a composition containing a silica aerogel powder and at least one selected from among infrared shielding particles, inorganic fibers, and dispersants may be prepared, and a press-molded component may be produced.

The thermal insulator using the silica aerogel powder suppresses mainly conduction and convection among three forms of heat transfer (conduction, convection, and radiation), and thus a high thermal insulation effect can be obtained. Here, radiation is a phenomenon in which heat is transferred by electromagnetic waves, and the higher the temperature, the larger the amount of radiant energy emitted. Therefore, in a high-temperature atmosphere, radiation becomes the main factor of heat transfer. Infrared shielding particles absorb heat from a heat source, re-emit the absorbed heat from the surface on the side of the heat source, and thus block radiant heat from the heat source. Therefore, when infrared shielding particles that can suppress heat transfer due to radiation are used in combination, heat transfer due to radiation in addition to conduction and convection can be suppressed, and high thermal insulation can be achieved not only at a room temperature but also at a high temperature of 500° C. or higher. In addition, when inorganic fibers are added, it is possible to improve the mechanical strength of the thermal insulator and suppress a situation in which the silica aerogel particles fall off. The silica aerogel powder is not easily mixed with water, and is not easily dispersed. Therefore, when an amphiphilic dispersant is added, the dispersibility of the silica aerogel powder can be improved when water is used in the process of producing the thermal insulator. In addition, when a dispersant is added, press-moldability of the silica aerogel powder can be improved.

(5) In the configuration according to any one of (2) to (4), the silica aerogel powder may have an average particle size of 30 μm or more and 150 μm or less. This configuration is preferable from the perspective of improving thermal insulation, maintaining strength, and suppressing a situation in which the silica aerogel particles fall off.

(6) In the configuration according to any one of (2) to (5), the thermal insulator for a battery pack of the present disclosure may be used in a vehicle. According to this configuration, even when vibration and the like occur while the vehicle travels, it is possible to suppress positional displacement of the battery cells and maintain high thermal insulation.

(7) A second thermal insulator for a battery pack of the present disclosure is a thermal insulator for a battery pack, the thermal insulator including a silica aerogel, and is characterized in that, when the silica aerogel is measured by a nitrogen adsorption amount measurement method, a specific surface area and a pore volume at a relative pressure of 0.99 measured based on an adsorption isotherm that is obtained are 550 m²/g or more, and 3.5 mL/g or more and 5.0 mL/g or less, respectively, and when a [mL/g] is a pore volume at a relative pressure of 0.93, b [mL/g] is a pore volume at a relative pressure of 0.965, and c [mL/g] is a pore volume at a relative pressure of 0.99, the following conditions (i) and (ii) are satisfied:

$$0 \leq ( a / c \times 100 ) \leq 50 \qquad ( i )$$

$$50 \leq ( b / c \times 100 ) < 100 . \qquad ( ii )$$

The silica aerogel constituting the second thermal insulator for a battery pack of the present disclosure has a specific surface area and a pore volume at a relative pressure of 0.99 within predetermined ranges, and satisfies the conditions (i) and (ii), similar to the silica aerogel powder described in (1). Therefore, the silica aerogel in this configuration has high thermal insulation and excellent compression recovery. Therefore, according to the second thermal insulator for battery packs of the present disclosure, the thermal insulator deforms in response to the expansion and contraction of the battery cells, and thus it is possible to suppress positional displacement and maintain high thermal insulation. In addition, since the expansion and contraction of the battery cells are maintained appropriately, this can contribute to prolonging the lifespan of the battery cells.

(8) In the configuration according to (7), the thermal insulator for a battery pack of the present disclosure may further include at least one selected from among infrared shielding particles and dispersants. As described in (4), when infrared shielding particles are used in combination, heat transfer due to radiation in addition to conduction and convection can be suppressed, and high thermal insulation can be achieved not only at a room temperature but also at a high temperature of 500° C. or higher. In addition, the silica aerogel is not easily mixed with water, and is not easily dispersed. Therefore, when an amphiphilic dispersant is added, the dispersibility of the silica aerogel can be improved when water is used in the process of producing the thermal insulator.

(9) In the configuration according to (7) or (8), the thermal insulator for a battery pack of the present disclosure may be used in a vehicle. According to this configuration, even when vibration and the like occur while the vehicle travels, it is possible to suppress positional displacement of the battery cells and maintain high thermal insulation.

(10) In the configuration according to any one of (7) to (9), the thermal insulator for a battery pack of the present disclosure may further include a fiber material. According to this configuration, the mechanical strength of the thermal insulator can be improved.

### Effects of the Invention

Since the silica aerogel powder and the silica aerogel of the present disclosure have a unique pore structure with a large proportion of pores that contribute to thermal insulation and compression recovery, they have high thermal insulation and excellent compression recovery. The thermal insulator for a battery pack of the present disclosure using the silica aerogel powder or the silica aerogel of the present disclosure can deform in response to deformation of a counter member, and exhibits a high thermal insulation effect.

### BRIEF DESCRIPTION OF THE DRAWINGS

FIG. 1 is a graph showing adsorption isotherms of silica aerogel powders of examples and comparative examples.

FIG. 2A is a schematic view showing a configuration of an upper jig and a lower jig constituting a compression device.

FIG. 2B is a schematic view showing a state of the device at maximum compression.

FIG. 2C is a schematic view showing a state of the device upon unloading.

FIG. 3 is a graph showing a relationship between compressibility and a compressive stress in a tenth compression-unloading cycle.

### MODES FOR CARRYING OUT THE INVENTION

Hereinafter, the silica aerogel powder and the thermal insulator for a battery pack of the present disclosure will be described in detail. The silica aerogel powder and the thermal insulator for a battery pack of the present disclosure are not limited to the following forms, and can be realized in various forms that are modified and improved by those skilled in the art without departing from the spirit and scope of the present disclosure.

### <Silica Aerogel Powder>

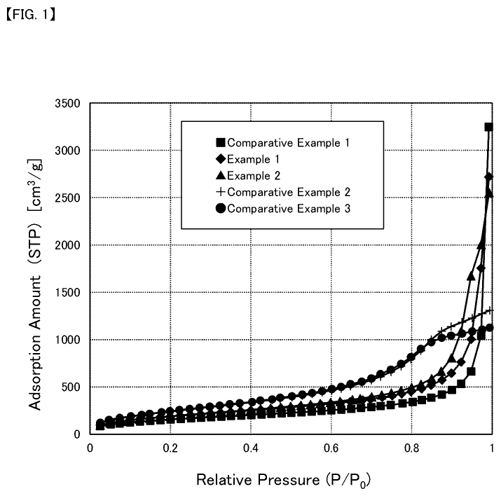

Silica aerogel particles have a framework formed by connecting a plurality of primary particles, and pores are formed between the frameworks. It is preferable that the diameter of the primary particles forming the framework be approximately 2 to 5 nm. The specific surface area and the pore volume of the silica aerogel powder of the present disclosure are measured based on the adsorption isotherm obtained by a nitrogen adsorption amount measurement method. The nitrogen adsorption amount measurement method is a method of measuring the phenomenon in which nitrogen gas molecules are physically adsorbed onto the surface of a solid (silica aerogel) due to an intermolecular force at a low temperature (liquid nitrogen temperature). The adsorption isotherm is a curve obtained by measuring the adsorption amount while the pressure of nitrogen gas is increased and plotting the relative pressure of nitrogen gas on the horizontal axis and the adsorption amount of nitrogen gas on the vertical axis, as shown in FIG. 1 below. The relative pressure on the horizontal axis is the ratio (P/P₀) of the adsorption equilibrium pressure (P) of the nitrogen gas to the saturated vapor pressure (P₀).

The specific surface area and pore volume values in this specification are values obtained by measuring the nitrogen gas adsorption amount using a high-vacuum physisorption/chemisorption analyzer “Autosorb iQ” (commercially available from Anton Paar). The specific surface area is a value calculated by a BET multi-point method using the value of the nitrogen gas adsorption amount in a relative pressure range of 0.1 to 0.3. The pore volumes at a relative pressure of 0.99, 0.965, and 0.93 are values calculated by a BJH method using the values of respective nitrogen gas adsorption amounts.

### [Specific Surface Area]

The specific surface area of the silica aerogel powder of the present disclosure is 550 m²/g or more. This is because, when the specific surface area is less than 550 m²/g, the proportion of micropores with a pore diameter of approximately several nanometers increases, and the proportion of pores with a pore diameter of approximately 30 to 68 nm, the pores being effective in improving thermal insulation, decreases.

### [Pore Volume at Relative Pressure of 0.99]

The pore volume at a relative pressure of 0.99 of the silica aerogel powder of the present disclosure, the pore volume being measured by the nitrogen adsorption amount measurement method, is 3.5 mL/g or more and 5.0 mL/g or less. Since this condition excludes the particles containing a large number of pores with a pore diameter exceeding 100 nm, a silica aerogel powder containing a large number of pores with a pore diameter that contributes to thermal insulation and compression recovery can be realized.

[Conditions (i) and (ii)]

When the pore volume at a relative pressure of 0.93 is a [mL/g], the pore volume at a relative pressure of 0.965 is b [mL/g], and the pore volume at a relative pressure of 0.99 is c [mL/g], which are measured by the nitrogen adsorption amount measurement method, the silica aerogel powder of the present disclosure satisfies the following conditions (i) and (ii).

$$0 \leq ( a / c \times 100 ) \leq 50 \qquad ( i )$$

$$50 \leq ( b / c \times 100 ) < 100 \qquad ( ii )$$

The condition (i) is a condition that mainly relates to compression recovery, and indicates that there are no or a small number of pores with a pore diameter of up to approximately 30 nm. The condition (ii) is a condition that mainly relates to thermal insulation, and indicates that there are many pores with a pore diameter of up to approximately 68 nm.

### <Method of Producing Silica Aerogel Powder>

The silica aerogel powder of the present disclosure may be produced through a sol-gel reaction of a silane compound. From the perspective of easily designing the framework and the pore structure of the silica aerogel in a desired state, two or more types of compounds with different numbers of siloxane bonds may be used as the silane compound. In this specification, the term “siloxane bond” in the silane compound refers to a bond (Si—O bond) between a silicon atom (Si) and an oxygen atom (O). Here, “the number of siloxane bonds” refers to the number of oxygen atoms bonded to a single silicon atom, and the silane compounds are classified into four types in which the number of siloxane bonds is 1 to 4. The silane compounds may include compounds with different numbers of siloxane bonds, or may include a plurality of types of compounds with the same number of siloxane bonds.

From the perspective of increasing the amount of elastic deformation of the silica aerogel powder, the silane compound is preferably in the form of a tetrafunctional silane compound and a trifunctional silane compound. In this form, the content of the trifunctional silane compound is preferably 65 mass % or more, based on 100 mass % of the total content of the silane compounds. The content is more preferably 70 mass % or more and still more preferably 80 mass % or more. When the content of the trifunctional silane compound is increased, the proportion of —O—Si—O— bonds decreases in the obtained silica aerogel powder. In addition, the proportion of pores with a relatively large pore diameter increases. This can increase the amount of elastic deformation of the silica aerogel powder. On the other hand, from the perspective of increasing the proportion of pores with a relatively small pore diameter, the pores being effective in improving thermal insulation, the content of the tetrafunctional silane compound is preferably 5 mass % or more and more preferably 10 mass % or more, based on 100 mass % of the total content of the silane compounds.

The configuration of the silane compound used in the production of the silica aerogel powder can be analyzed by a dipolar decoupling (DD) method using solid-state ²⁹Si-NMR. That is, in the solid-state ²⁹Si-NMR spectrum of the silica aerogel powder, the abundance proportions of Q unit, T unit, D unit, and M unit (Q unit where a silicon atom is bonded to four oxygen atoms, T unit where a silicon atom is bonded to three oxygen atoms, D unit where a silicon atom is bonded to two oxygen atoms, and M unit where a silicon atom is bonded to one oxygen atom) calculated from the signal area correspond to the contents of the tetrafunctional silane compound, the trifunctional silane compound, the bifunctional silane compound, and the monofunctional silane compound contained in the silane compound-containing solution.

Examples of tetrafunctional silane compounds include tetraalkoxysilane and tetraacetoxysilane. The alkoxy group of the tetraalkoxysilane preferably has 1 to 9 carbon atoms. Examples thereof include tetramethoxysilane, tetraethoxysilane, tetrapropoxysilane, and tetraisopropoxysilane. Examples of trifunctional silane compounds include trialkoxysilane and triacetoxysilane. The alkoxy group of the trialkoxysilane preferably has 1 to 9 carbon atoms. Examples thereof include methyltrimethoxysilane, ethyltrimethoxysilane, propyltrimethoxysilane, hexyltrimethoxysilane, octyltrimethoxysilane, methyltriethoxysilane, ethyltriethoxysilane, propyltriethoxysilane, pentyltriethoxysilane, hexyltriethoxysilane, and octyltriethoxysilane. Examples of bifunctional silane compounds include dialkoxysilane and diacetoxysilane. The alkoxy group of the dialkoxysilane preferably has 1 to 9 carbon atoms. Examples thereof include dimethyldimethoxysilane, diethyldimethoxysilane, and diisobutyldimethoxysilane. Examples of monofunctional silane compounds include methoxytrimethylsilane, isopropoxytrimethylsilane, ethoxytrimethylsilane, tert-butoxytrimethylsilane, ethoxytriethylsilane, methoxydimethyl(phenyl)silane, trimethyl(vinyloxy)silane, and isopropenyloxytrimethylsilane.

The method of producing a silica aerogel powder using the sol-gel reaction includes a sol formation step, a gelling step, and a drying step. In order to obtain a desired pore structure, the conditions such as agents to be used and a temperature and time in each step may be appropriately adjusted. First, in the sol formation step, a sol is formed by adding a predetermined silane compound to an aqueous solution containing an acid catalyst and hydrolyzing the silane compound. An organic solvent, a surfactant, a water-soluble oligomer having both polar and non-polar components in the side chain and the like may be added to the aqueous solution. As the organic solvent, an alcohol-based solvent is preferable in consideration of compatibility after hydrolysis of the silane compound with an acid catalyst. Examples thereof include methanol, ethanol, and isopropyl alcohol. Next, in the gelling step, a basic catalyst is added to the formed sol to cause polycondensation of the sol to form a gel. As the basic catalyst, a quaternary ammonium salt is preferable, and for example, tetramethylammonium hydroxide may be used. After the basic catalyst is added, in order to proceed the polycondensation reaction and form a desired pore structure, the mixture may be left and cured for 6 to 12 hours under heating at 90 to 120° C. Subsequently, in the drying step, the formed gel is dried. The drying method may be either a supercritical drying method or a non-supercritical drying method (normal-pressure drying method, freeze-drying method). For example, when drying is performed at normal pressure, it may be performed under heating at 80 to 100° C. for 2 to 3 hours. Here, aerogels such as silica aerogels are sometimes distinguished based on the difference in drying methods during production: “xerogel” when dried at normal pressure, “aerogel” when dried under supercritical conditions, and “cryogel” when freeze-dried; however, in this specification, these are collectively referred to as “aerogel.”

When drying is performed at normal pressure, before the drying step, a solvent replacement step in which water adhering to a gel is replaced with an organic solvent that can be dried at normal pressure may be performed. In addition, when drying is performed at normal pressure, since drying proceeds slowly compared to supercritical drying, there is a risk of pores shrinking due to the action of the basic catalyst remaining in the gel and a desired pore structure not being obtained. From the perspective of suppressing contraction of pores during drying, it is preferable to perform a washing step in which the basic catalyst is removed from the gel before the drying step. The gel may be washed by heating it, for example, to 40 to 50° C., adding the organic solvent used in the sol formation step, and releasing the basic catalyst due to the difference in concentration between the inside and the outside of the gel. On the other hand, when supercritical drying is performed, since drying proceeds quickly, pores are less likely to contract even when the basic catalyst remains in the gel. However, when the basic catalyst remains in the silica aerogel, there is a risk of thermal degradation. Therefore, even when supercritical drying is used, it is preferable to perform a washing step in which the basic catalyst is removed from the gel before the drying step. A silica aerogel powder may be produced by crushing the obtained silica aerogel using a media-less crushing and mixing device such as a jet mill, a stirrer, and the like.

### <Thermal Insulator for Battery Pack>

A first thermal insulator for a battery pack of the present disclosure is formed using the silica aerogel powder of the present disclosure. A first form of the first thermal insulator for a battery pack of the present disclosure includes a form in which a press-molded component of a composition containing a silica aerogel powder is included. A second form includes a form in which a thermal insulation layer is included, the thermal insulation layer being produced by applying a liquid (including a slurry) composition obtained by adding a solvent such as water to a silica aerogel powder to a substrate and drying the substrate. These two forms of compositions may be composed of only a silica aerogel powder, or may be formed by adding other components to a silica aerogel powder. In addition, a second thermal insulator for a battery pack of the present disclosure may be made from a silica aerogel produced through the sol-gel reaction of the silane compound without making it into a powder.

When the silica aerogel powder is used, the average particle size may be 10 μm or more from the perspective of improving thermal insulation. In the form of the press-molded component, the average particle size is preferably 30 μm or more and more preferably 50 μm or more from the perspective of reducing fine voids between particles and increasing strength. On the other hand, from the perspective of achieving ease of molding into a sheet shape and suppressing a situation in which particles fall off, the average particle size is preferably 150 μm or less and more preferably 120 μm or less. When the thermal insulation layer is produced, in consideration of the stability of a liquid composition and ease of application, the average particle size may be 100 μm or less. The average particle size of the silica aerogel powder may be the median diameter (D₅₀) determined from a volume-based particle size distribution measured by a laser diffraction/scattering method.

From the perspective of securing desired thermal insulation, the content of the silica aerogel powder in the composition may be 65 mass % or more based on 100 mass % of the solid content of the composition. The content is preferably 70 mass % or more. Here, the solid content refers to components obtained by excluding volatile substances such as an organic solvent and water. Examples of components other than the silica aerogel powder contained in the thermal insulator for a battery pack of the present disclosure include infrared shielding particles, inorganic fibers, dispersants, reinforcing inorganic particles, and flame retardants. Here, a form including a binder that binds constituent components such that silica aerogel particles do not fall off is also conceivable. However, there is a risk of a heat transfer path being formed through a binder, and there is also a risk of the effect achieved by the pore structure of the silica aerogel powder being inhibited. Therefore, it is preferable that the thermal insulator for a battery pack of the present disclosure do not contain a binder that binds constituent components such as the silica aerogel powder. Hereinafter, the other components will be described.

### [Infrared Shielding Particles]

Infrared shielding particles absorb heat from a heat source, re-emit it from the surface on the side of the heat source, and thus block radiant heat from the heat source, and contribute to improving thermal insulation, particularly at a high temperature. The particle size of the infrared shielding particles is preferably relatively small from the perspective of allowing them to be filled into the gaps (voids) between silica aerogel particles, suppressing the connections between infrared shielding particles or with other components, and making it difficult to form a heat transfer path. However, when the particle size is too small, the particles are less likely to be exposed to infrared rays, scattering of infrared rays also becomes insufficient, and thus it is difficult to achieve the effect of blocking radiant heat. In this regard, the average particle size of the infrared shielding particles may be 0.3 μm or more and 22 μm or less. The shape of the infrared shielding particles is not particularly limited, and may be a spherical shape, a flat shape, or the like. For the average particle size of the infrared shielding particles, similarly to the silica aerogel powder, the median diameter (D₅₀) determined from a volume-based particle size distribution measured by a laser diffraction/scattering method may be used, and when a commercially available product is used, catalog values may be used.

Examples of infrared shielding particles include particles of one type selected from among silicon carbide, kaolinite, montmorillonite, titanium oxide, silicon nitride, mica, alumina, aluminum nitride, boron carbide, iron oxide, magnesium oxide, tin oxide, zinc oxide, tantalum oxide, manganese ferrite, manganese oxide, nickel oxide, nickel, silver oxide, silver, bismuth oxide, carbon black, graphite, titanium, titanium iron oxide, zirconium, zirconia, zirconium silicate, barium titanate, manganese dioxide, chromium oxide, titanium carbide, tungsten carbide, tungsten oxide, niobium oxide, indium tin oxide, and cerium oxide, or mixed particles of two or more types selected from among these. Among these, from the perspective of improving the effect of blocking radiant heat, it is preferable that the infrared shielding particles include high-emissivity particles having an emissivity of 0.6 or more in the infrared wavelength range. Examples of high-emissivity particles include silicon carbide, kaolinite, silicon nitride, mica, alumina, zirconia, aluminum nitride, zirconium silicate, cerium oxide, boron carbide, manganese oxide, tin oxide, and iron oxide. In addition, from the perspective of improving the effect of blocking radiant heat by scattering incident infrared rays, a form including particles having a high refractive index in the infrared wavelength range is also effective. For example, high-refractive-index particles having a refractive index of 2.0 or more in the visible light wavelength range are preferable. Examples of high-refractive-index particles include silicon carbide, titanium oxide, zirconia, silicon nitride, aluminum nitride, zinc oxide, tantalum oxide, tungsten oxide, niobium oxide, cerium oxide, manganese oxide, tin oxide, bismuth oxide, iron oxide, and barium titanate.

For example, silicon carbide, titanium oxide, silicon nitride, mica, alumina, aluminum nitride, boron carbide, iron oxide, magnesium oxide, and the like have relatively large specific heat and a large heat capacity, and thus the particles themselves do not heat up easily. In this respect, they also contribute to improving thermal insulation of the thermal insulator. In addition, they also have high heat resistance, which also contributes to improving heat resistance of the thermal insulator. Silicon carbide is particularly preferable because its thermal conductivity does not increase much even in a high-temperature atmosphere of approximately 500 to 800° C.

### [Inorganic Fibers]

Inorganic fibers are physically entangled around the silica aerogel particles, improve the mechanical strength of the thermal insulator, and suppress a situation in which the silica aerogel particles fall off. The type of the inorganic fibers is not particularly limited, and in consideration of the heat resistance and mechanical strength, ceramic fibers such as glass fibers and alumina fibers are preferable. The length of the inorganic fibers is preferably 16 mm or less in consideration of both the reinforcement effect and suppression of the formation of a heat transfer path.

### [Dispersant]

In a case where a dispersant is used when the silica aerogel is crushed or when the liquid composition for producing the thermal insulation layer is prepared, it is possible to improve the dispersibility of the silica aerogel powder. Preferable dispersants include a surfactant and a water-soluble oligomer having both polar and non-polar components in the side chain. Examples of surfactants include ionic surfactants (cationic surfactant, anionic surfactant, amphoteric surfactant) and nonionic surfactants. For example, when an ionic surfactant is used, the viscosity of the composition can increase even in a relatively small amount, and the dispersion of materials such as a silica aerogel powder in the composition can be stabilized. Examples of ionic surfactants include sodium carboxymethylcellulose (CMC-Na), polycarboxylic acid amine salts, polycarboxylic acid ammonium salts, polycarboxylic acid sodium salts, and TEMPO-oxidized cellulose nanofibers (CNF-Na). When a nonionic surfactant is used, materials such as a silica aerogel powder are easily incorporated into the solvent during preparation of a composition. In addition, when these materials aggregate or separate in the composition, they become easier to redisperse, and the solvent is likely to be released during press-molding. Examples of nonionic surfactants include polyethylene oxide (PEO) and polyvinyl alcohol (PVA).

### [Reinforcing Inorganic Particles]

From the perspective of improving the mechanical strength of the thermal insulator, reinforcing inorganic particles may be incorporated. The type of the reinforcing inorganic particles is not particularly limited, and for example, particles having a relatively large hardness and specific surface area such as precipitated silica, gel silica, fused silica, wollastonite, potassium titanate, magnesium silicate, glass flakes, calcium carbonate, and barium sulfate can be used.

### [Flame Retardant]

A flame retardant may be added to the thermal insulator from the perspective of imparting flame retardancy. Conventionally known flame retardants such as a halogen-based flame retardant, a phosphorus-based flame retardant, and a metal hydroxide-based flame retardant may be used. In consideration of an environmental load, it is preferable to use a phosphorus-based flame retardant. Examples of phosphorus-based flame retardants include ammonium polyphosphate, red phosphorus, and phosphate ester. Among these, a flame retardant that is insoluble in water or coated with a water-resistant resin is preferable because the flame retardant is less likely to leak even when the thermal insulator comes into contact with water during use, and for example, ammonium polyphosphate and resin-coated ammonium polyphosphate are preferable.

### <Method of Producing Thermal Insulator for a Battery Pack>

When the first form of the press-molded component is produced as the first thermal insulator for a battery pack of the present disclosure, the composition may be put into a mold and pressed at a surface pressure of approximately 0.1 to 2.0 MPa while heating at a temperature of approximately 100 to 160° C. The thermal insulator for a battery pack of the present disclosure may be composed of only a press-molded component, or may include a substrate that supports the press-molded component and an exterior body that accommodates the press-molded component together. The substrate may be disposed only on one side of the thermal insulator in the thickness direction, or may be disposed on both sides of the thermal insulator in a sandwiching manner. In addition, the thermal insulator may be covered with a single substrate, and the substrate may be used as an exterior body. An adhesive layer may be interposed between the thermal insulator and the substrate. The adhesive layer may contain a flame retardant in addition to adhesive components.

When the second form of the thermal insulation layer is produced as the first thermal insulator for a battery pack of the present disclosure, the composition may be applied to the substrate by brushing or by using a coating machine such as a blade coater, a bar coater, a die coater, a comma coater (registered trademark), and a roll coater, or by spraying. Alternatively, production may be performed by immersing a substrate in a composition or forming a composition on a substrate by a papermaking method. Drying may be performed at a temperature of 80 to 180° C. for several minutes to several tens of minutes.

Examples of materials of the substrate include a cloth, a resin, a paper, and a steel sheet. Examples of fibers constituting the cloth include glass fibers, rock wool, ceramic fibers, alumina fibers, silica fibers, carbon fibers, metal fibers, polyimide fibers, aramid fibers, and polyphenylene sulfide (PPS) fibers. As ceramic fibers, refractory ceramic fibers (RCF), polycrystalline alumina fibers (Polycrystalline Wool: PCW), and alkaline earth silicate (AES) fibers are known. Among these, the AES fibers are safer because they are biosoluble. Examples of resins include polyethylene terephthalate (PET), polyimide, polyamide, and PPS. Examples of paper include pulp and composite materials of pulp and magnesium silicate. Examples of steel sheets include Galvalume steel sheets (registered trademark), galvanized sheets, stainless steel (SUS) sheets, iron sheets, and titanium sheets. The shape of the substrate is not particularly limited, and examples thereof include a woven fabric, a nonwoven fabric, a film, and a sheet. The substrate may be a single layer or a laminate in which two or more layers of the same material or different materials are laminated.

For example, glass cloth, fabrics (woven fabrics) and nonwoven fabrics made from inorganic fibers such as glass fibers and metal fibers, and fire-resistant insulating papers produced as composite materials of pulp and magnesium silicate, have relatively low thermal conductivity and exhibit excellent shape retention even in a high-temperature atmosphere. In addition, when a substrate having fire resistance is used, safety is further improved. The substrate having high heat resistance may be made from glass fibers, rock wool, ceramic fibers, polyimide, PPS or the like, and specific examples thereof include glass fiber nonwoven fabrics, glass cloth, aluminum glass cloth, AES wool paper, and polyimide fiber nonwoven fabrics.

The second thermal insulator for a battery pack of the present disclosure may be produced using the silica aerogel produced through the above sol formation step, gelling step, drying step and the like, without making it into a powder. For example, in the gelling step, a fiber material may be added together with the formed sol. When the fiber material is added, it is possible to strengthen the thermal insulator. The fiber material may be not only a thread-like material but also a cloth-like material (corresponding to the above substrate) such as a nonwoven fabric or a woven fabric. When cloth is used, a sol may be applied to the cloth, or the cloth may be immersed in a sol to form a gel. The fiber material may be either an inorganic fiber or an organic fiber, or may include both of them. When the fiber material is a thread-like material, the fiber material is dispersed within the thermal insulator and the fiber material is physically entangled with the silica aerogel, and thus the mechanical strength of the thermal insulator can be improved. In addition, when the fiber material is a cloth-like material, the cloth and the silica aerogel are bonded to each other, and thus the mechanical strength of the thermal insulator can be improved.

The specific surface area and the pore volume of the silica aerogel constituting the second thermal insulator for a battery pack of the present disclosure can be measured by the same method as the method of measuring the specific surface area and the pore volume of the silica aerogel powder of the present disclosure described above. For example, the silica aerogel may be crushed, and the nitrogen gas adsorption amount of the collected powder may be measured.

### EXAMPLES

Next, the present disclosure will be described in more detail with reference to examples.

### (1) Pore Structure and Compression Recovery of Silica Aerogel Powder

### <Production of Silica Aerogel Powder>

### Example 1

First, at a room temperature (20° C.±5° C.), a tetrafunctional silane compound (tetramethoxysilane), a trifunctional silane compound (methyltrimethoxysilane), water, and methanol were stirred and mixed, acetic acid was then added as an acid catalyst, the mixture was stirred for 10 minutes, and the silane compound was hydrolyzed to form a sol (sol formation step). The mixing ratio of tetramethoxysilane and methyltrimethoxysilane was 10:90 (mass ratio). Next, methanol and tetramethylammonium hydroxide as a basic catalyst were added to the formed sol, and the mixture was stirred for 1 minute and then left in a closed container at the room temperature for 1 hour. In addition, the sample was left at 90° C. for 6 hours and cured (heat treatment), and the sol was polycondensed to form a gel (gelling step). Then, methanol was added to the gel at 40° C., and the basic catalyst was removed from the gel (washing step). Then, the washed gel was dried at normal pressure and 80° C. for 2 hours to produce a silica aerogel of Example 1 (drying step).

### Example 2 and Comparative Examples 1 to 3

Four types of silica aerogels, Example 2 and Comparative Examples 1 to 3, were produced in the same manner as in Example 1 except that a mixing ratio of a tetrafunctional silane compound (tetramethoxysilane) and a trifunctional silane compound (methyltrimethoxysilane) was changed. The mixing ratios of the silane compounds in respective silica aerogels are shown in Table 1 below. In addition, the produced silica aerogel was crushed using a Henschel mixer and formed into a powder, and subjected to the following measurement.

### <Measurement of Specific Surface Area and Pore Volume>

The nitrogen gas adsorption amount of the produced silica aerogel powder was measured at a liquid nitrogen temperature (−196° C.), and the specific surface area and the pore volume were determined based on the obtained adsorption isotherm. The nitrogen gas adsorption amount was measured using a high-vacuum physisorption/chemisorption analyzer “Autosorb iQ” (commercially available from Anton Paar) in the relative pressure range of 0.025 to 0.995. The specific surface area was determined by a BET multi-point method using the value of the nitrogen gas adsorption amount in a relative pressure range of 0.1 to 0.3. The pore volumes at a relative pressure of 0.93, 0.965, and 0.99 were determined by a BJH method using the values of respective nitrogen gas adsorption amounts. The silica aerogel powder sample was degassed as follows before measurement. First, the sample was put into a dry heat oven, and maintained at 117° C. for 3 hours. Next, the sample was set in the measurement device and degassed under a reduced pressure at 120° C. for 2 hours.

FIG. 1 shows adsorption isotherms of silica aerogel powders of examples and comparative examples. In addition, Table 1 shows specific surface areas and pore volumes of the silica aerogel powders.

TABLE 1

| | | Comparative | Example | Example | Comparative | Comparative |
|---|---|---|---|---|---|---|
| | | Example 1 | 1 | 2 | Example 2 | Example 3 |
| Mixing ratio | Trifunctional silane compound | 100 | 90 | 70 | 60 | 50 |
| (mass ratio) | Tetrafunctional silane compound | 0 | 10 | 30 | 40 | 50 |
| Specific surface area [m²/g] | | 565 | 718 | 742 | 953 | 965 |
| Pore volume | a: relative pressure 0.93 | 0.8 | 1.2 | 1.7 | 1.8 | 1.6 |
| [mL/g] | b: relative pressure 0.965 | 1.3 | 2.4 | 3.0 | 2.0 | 1.7 |
| | c: relative pressure 0.99 | 5.0 | 4.2 | 4.1 | 2.1 | 1.8 |
| Condition (i) | a/c × 100 [%] | 17 | 28 | 42 | 89 | 93 |
| | Determination | ◯ | ◯ | ◯ | X | X |
| Condition (ii) | b/c × 100 [%] | 27 | 57 | 74 | 98 | 96 |
| | Determination | X | ◯ | ◯ | ◯ | ◯ |
| Evaluation | Thermal insulation | X | ◯ | ◯ | X | X |
| results | Compression recovery | ◯ | ◯ | ◯ | X | X |

As shown in FIG. 1, in the silica aerogel powders of Examples 1 and 2 and Comparative Example 1 having a relatively large content of the trifunctional silane compound, the pore volume (total pore volume) at a relative pressure of 0.99 was large, and the proportion of pores with a small pore diameter was reduced compared to the silica aerogel powders of Comparative Examples 2 and 3. In addition, as shown in Table 1, the silica aerogel powders of Examples 1 and 2 satisfied all of the specific surface area, the pore volume at a relative pressure of 0.99, and the conditions (i) and (ii).

### <Evaluation of Compression Recovery>

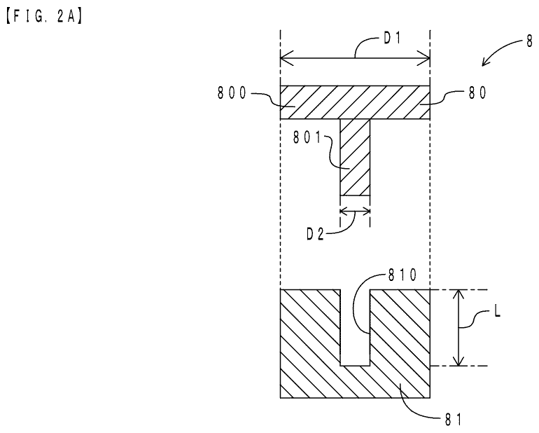

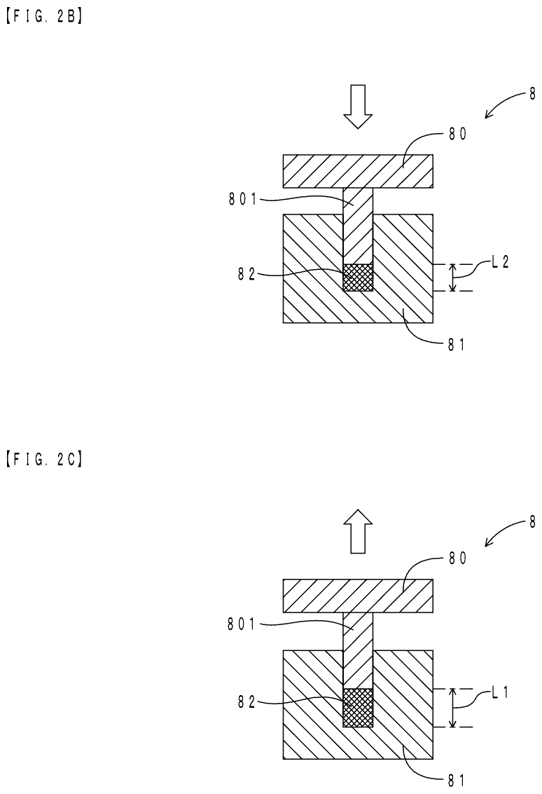

The compression recovery of the produced silica aerogel powder was measured using a compression device shown in FIG. 2A to FIG. 2C. FIG. 2A is a schematic view showing a configuration of an upper jig and a lower jig constituting the compression device. FIG. 2B is a schematic view showing a state of the device at maximum compression, and FIG. 2C is a schematic view showing a state of the device upon unloading. As shown in FIG. 2A, a compression device 8 includes an upper jig 80 and a lower jig 81. The upper jig 80 is made of stainless steel, and includes a disc-shaped base 800 and a cylindrical piston part 801 that is disposed in the central part of the base 800 and protrudes downward. The diameter D1 of the base 800 is 50 mm, and the diameter D2 of the piston part 801 is 11.3 mm. The length of the piston part 801 is 27 mm, which is the same as the depth L of a recess 810 of the lower jig 81 to be described below. The lower jig 81 is also made of stainless steel, and has a cylindrical shape with the same diameter D1 as the base 800 of the upper jig 80. The cylindrical recess 810 in which the piston part 801 is accommodated is formed in the central part of the lower jig 81. The depth L of the recess 810 is 27 mm.

The method of measuring the compression recovery is as follows. First, the produced silica aerogel powder was sieved through a stainless steel sieve with 125 μm openings, and the powder that has passed was again sieved through a stainless steel sieve with 75 μm openings. The powder with a particle size of 75 μm to 125 μm, which remains on the sieve, was used for measurement of the compression recovery. Next, the sieved silica aerogel powder was filled into the recess 810 of the lower jig 81 while the lower jig 81 was tapped up and down. The amount of the silica aerogel powder filled was set to a height of 13 mm±1 mm from the bottom of the recess 810. Then, using a tensilon universal material testing machine “RTF1350” (commercially available from A&D Co., Ltd.), as shown by the downward white arrow in FIG. 2B, the upper jig 80 was moved downward at a rate of 12 mm/min, and a silica aerogel powder 82 was compressed using the piston part 801 until the compressive stress reached 3.0 MPa. Then, as shown by the upward white arrow in FIG. 2C, the upper jig 80 was moved upward at a rate of 12 mm/min until the compressive stress reached 0 MPa, and unloaded. This compression-unloading operation was performed 10 times, and the recovery rate was calculated from the displacement amount of the filling height of the silica aerogel powder 82 in a tenth compression-unloading cycle.

The recovery rate was calculated by the following formula (I), where L2 (mm) is the filling height of the silica aerogel powder at a compressive stress of 3.0 MPa (refer to FIG. 2B), and L1 (mm) is the filling height of the silica aerogel powder upon unloading (refer to FIG. 2C). Then, when the recovery rate was 25% or more, it was evaluated as satisfactory (indicated by ◯ in Table 1), and when the recovery rate was less than 25%, it was evaluated as unsatisfactory (indicated by X in Table 1). The evaluation results of the compression recovery of respective silica aerogel powders are summarized in Table 1.

$$Recovery rate ( \% ) = ( L 1 - L 2 ) / L 1 \times 100 \qquad ( I )$$

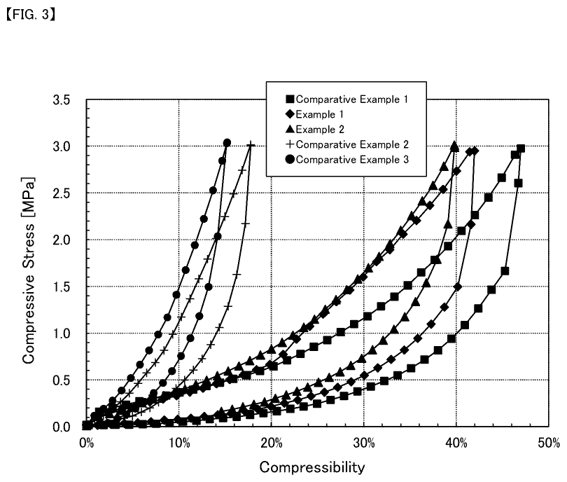

In addition, FIG. 3 is a graph showing a relationship between compressibility and the compressive stress in the tenth compression-unloading cycle. In the graph in FIG. 3, the compressibility on the horizontal axis is the value calculated by the following formula (II).

$$Compressibility ( \% ) = compression displacement amount ( mm ) of silica aerogel powder / filling height ( mm ) of initial ( unloaded ) silica aerogel powder \times 100 \qquad ( II )$$

As shown in Table 1, it was confirmed that the silica aerogel powders of Examples 1 and 2 had high compression recovery. On the other hand, the silica aerogel powders of Comparative Examples 2 and 3 had a small pore volume (total pore volume) at a relative pressure of 0.99, and also had a large value of a/c in the condition (i), and a large proportion of pores with a small pore diameter, resulting in low elasticity and poor compression recovery.

### (2) Thermal Insulation of Silica Aerogel Powder

The produced silica aerogel powder was press-molded to produce a thermal insulator sample, and its thermal insulation was evaluated.

### <Production of Thermal Insulator Sample>

### [Production of Composition]

First, water was weighed out in a resin container, a surfactant (PEO) was added as a dispersant, the mixture was stirred using an air-driven blade stirrer at 800 rpm for 60 minutes, and the surfactant was dissolved in water. After stirring was stopped, a silicon carbide (SiC) powder was added as infrared heat shielding particles, and the mixture was additionally stirred at 800 rpm for 15 minutes. While stirring continued, a silica aerogel powder was added and completely wetted in the liquid. Then, glass fibers as inorganic fibers were added, and the mixture was stirred at 800 rpm for 30 minutes. Then, the mixture was additionally stirred at 1,000 rpm for 10 minutes. In this manner, a composition containing a silica aerogel powder with an average particle size (D₅₀) of 70 μm was produced. The composition exhibited a clay-like form in which granular materials with a diameter of 5 mm or less were aggregated. The content of the silica aerogel powder in the composition was 73.7 mass % based on 100 mass % of the solid content of the composition. Similarly, the content of the surfactant in the composition was 2.9 mass %, the content of the silicon carbide powder was 15.1 mass %, and the content of the glass fibers was 8.3 mass %.

Details of materials other than the silica aerogel powder are as follows.
Silicon carbide powder: “Fuji Random GC #4000” (commercially available from Fuji Manufacturing Co., Ltd.), an average particle size of 5 μm.
Surfactant: polyethylene oxide “PEO-8” (commercially available from Sumitomo Seika Chemicals Co., Ltd.), a viscosity average molecular weight of 1.7 million to 2.2 million.
Glass fiber: “ECS03-615” (commercially available from Central Glass Fiber Co., Ltd.), a length of 3 mm, a fiber diameter of 9 m.

### [Production of Press-Molded Component]

The produced clay-like composition was press-molded as follows. First, a base was prepared by placing a first spacer plate made of SUS on glass fiber paper. The first spacer plate had a thickness of 7 mm and had a 150 mm square injection hole formed in the center. The produced composition was filled into the injection hole of the first spacer plate and molded into a square plate. Subsequently, the first spacer plate was removed, the glass fiber paper was placed on top, and the second spacer plate was then disposed on top of the glass fiber paper to produce a laminate composed of “glass fiber paper/composition/glass fiber paper/second spacer plate.” The second spacer plate had a thickness of 6 mm and had a 150 mm square injection hole formed in the center, as in the first spacer plate. The molded composition was accommodated in the injection hole of the second spacer plate.

Separately, a 320 mm square first plate material with a thickness of 5 mm and made of aluminum and a 320 mm square second plate material with a thickness of 1 mm and made of aluminum were prepared. A plurality of grooves was formed on one surface of the first plate material. The grooves each having a width of 2.5 mm, a depth of 3 mm, and a length of 200 mm were linearly formed in parallel at 5 mm intervals. Punching holes each having a diameter of 1 mm were formed at 2 mm intervals throughout the second plate material. The second plate material was placed on one surface of the first plate material, and the laminate was disposed on top of it. Then, the second plate material was placed on the laminate, and the first plate material was additionally placed thereon such that the one surface on which the grooves were formed faced the second plate material. In this state, press-molding was performed by heat-pressing at a temperature of 165° C. and a load of approximately 980 kN for 10 minutes. Then, cooling was performed to a room temperature, and the first plate material, the second plate material, the second spacer plate, and the upper and lower glass fiber papers were removed to obtain a square plate press-molded component with a thickness of 6 mm. The produced press-molded component was used as a thermal insulator sample, and referred to as a sample of Example 1 according to the used silica aerogel powder.

### <Evaluation of Thermal Insulation>

The thermal conductivity of the thermal insulator sample at 600° C. was measured using a “quick thermal conductivity meter QTM-700” and a “high temperature probe PD-31N” (commercially available from Kyoto Electronics Manufacturing Co., Ltd.) as follows. First, the thermal insulator samples were laminated to prepare two laminates each having a thickness of approximately 20 mm. The laminate was disposed on both the upper side and the lower side of the probe such that the probe was inserted therebetween, and was installed in the electric furnace after placing, on top, a weight with a mass of approximately 5 kg that is not heavy enough to crush the laminate. Then, the temperature in the electric furnace was raised to 600° C., the temperature in the furnace was stabilized, and the thermal conductivity was then measured. In this example, when the measured thermal conductivity was less than 0.12 W/m·K, it was evaluated as satisfactory (indicated by ◯ in Table 1), and when the thermal conductivity was 0.12 W/m·K or more, it was evaluated as unsatisfactory (indicated by X in Table 1). The evaluation results of the thermal insulation are summarized in Table 1.

As shown in Table 1, it was confirmed that the samples of Examples 1 and 2 had excellent thermal insulation. On the other hand, the sample of Comparative Example 1 had a small value of b/c in the condition (ii), and had a small number of pores with a pore diameter of up to approximately 68 nm, resulting in poor thermal insulation. In addition, the samples of Comparative Examples 2 and 3 had a value of b/c within a desired range in the condition (ii), and had a small pore volume (total pore volume) at a relative pressure of 0.99, resulting in reduced thermal insulation. In summary, it was confirmed that the silica aerogel powders of Examples 1 and 2 had excellent compression recovery, and the thermal insulator samples using the same had excellent thermal insulation at a high temperature.

### DESCRIPTION OF THE REFERENCE NUMERALS

8 . . . compression device, 80 . . . upper jig, 800 . . . base, 801 . . . piston part, 81 . . . lower jig, 810 . . . recess, 82 . . . silica aerogel powder

1. A silica aerogel powder used in a thermal insulator for a battery pack, characterized in that, when the silica aerogel powder is measured by a nitrogen adsorption amount measurement method, a specific surface area and a pore volume at a relative pressure of 0.99 measured based on an adsorption isotherm that is obtained are 550 m²/g or more, and 3.5 mL/g or more and 5.0 mL/g or less, respectively, and
when a [mL/g] is a pore volume at a relative pressure of 0.93, b [mL/g] is a pore volume at a relative pressure of 0.965, and c [mL/g] is a pore volume at a relative pressure of 0.99, the following conditions (i) and (ii) are satisfied:
$$0 \leq ( a / c \times 100 ) \leq 50 \qquad ( i )$$
$$50 \leq ( b / c \times 100 ) < 100 . \qquad ( ii )$$

2. A thermal insulator for a battery pack, the thermal insulator comprising the silica aerogel powder according to claim 1.

3. The thermal insulator for a battery pack according to claim 2, the thermal insulator comprising a press-molded component of a composition containing the silica aerogel powder.

4. The thermal insulator for a battery pack according to claim 2, the thermal insulator further comprising at least one selected from among infrared shielding particles, inorganic fibers, and dispersants.

5. The thermal insulator for a battery pack according to claim 2,
wherein the silica aerogel powder has an average particle size of 30 μm or more and 150 μm or less.

6. The thermal insulator for a battery pack according to claim 2, wherein the thermal insulator is used in a vehicle.

7. A thermal insulator for a battery pack, the thermal insulator including a silica aerogel, characterized in that, when the silica aerogel is measured by a nitrogen adsorption amount measurement method, a specific surface area and a pore volume at a relative pressure of 0.99 measured based on an adsorption isotherm that is obtained are 550 m²/g or more, and 3.5 mL/g or more and 5.0 mL/g or less, respectively, and
when a [mL/g] is a pore volume at a relative pressure of 0.93, b [mL/g] is a pore volume at a relative pressure of 0.965, and c [mL/g] is a pore volume at a relative pressure of 0.99, the following conditions (i) and (ii) are satisfied:
$$0 \leq ( a / c \times 100 ) \leq 50 \qquad ( i )$$
$$50 \leq ( b / c \times 100 ) < 100 . \qquad ( ii )$$

8. The thermal insulator for a battery pack according to claim 7, the thermal insulator further comprising at least one selected from among infrared shielding particles and dispersants.

9. The thermal insulator for a battery pack according to claim 7, wherein the thermal insulator is used in a vehicle.

10. The thermal insulator for a battery pack according to claim 7, the thermal insulator further comprising a fiber material.
